(19) United States
(12) Patent Application Publication
(10) Pub. No.: US 2007/0228176 A1
(43) Pub. Date: Oct. 4, 2007

(54) Imaging-based bar code reader with rotated photosensor array

(75) Inventors: Igor R. Vinogradov, New York, NY (US); Bradley S. Carlson, Huntington, NY (US); Edward Barkan, Miller Place, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: SYMBOL TECHNOLOGIES, INC., Holtsville, NY (US)

(21) Appl. No.: 11/395,638

(22) Filed: Mar. 31, 2006

(51) Int. Cl. G06K 7/10

(52) U.S. Cl. 235/462.46; 235/462.41

(57) ABSTRACT

An imaging based bar code reader for imaging and decoding a target bar code. The reader features a housing including a scanning head defining a horizontal axis and an imaging system supported by the housing for imaging the target bar code. The imaging system including a 2D sensor array and focusing optics receiving reflected illumination from the target bar code through the window and focusing the reflected illumination onto the sensor array. The sensor array includes an orthogonal array of pixels and defines a horizontal axis. The reader further features a decoding system for decoding an image of the target bar code. The sensor array is oriented such that the horizontal axis of the sensor array is at an acute angle with respect to the horizontal axis of the target bar code when the target bar code is being presented to the scanning head such that the horizontal axis of the target bar code is substantially parallel to the horizontal axis of the scanning head.

### FIELD OF THE INVENTION

The present invention relates to an imaging-based bar code reader including a sensor array which is rotated about an axis perpendicular to a sensor array surface such that a horizontal axis of the sensor array surface is at an acute angle with respect to a horizontal axis of a target bar code when the target bar code is presented for reading.

### BACKGROUND OF THE INVENTION

Various electro-optical systems have been developed for reading optical indicia, such as bar codes. A bar code is a coded pattern of graphical indicia comprised of a series of bars and spaces of varying widths, the bars and spaces having differing light reflecting characteristics. Systems that read and decode bar codes employing CCD or CMOS-based imaging systems are typically referred to as imaging-based bar code readers or bar code scanners.

The bar code reader includes an imaging and decoding system including an imaging system for generating an image of a target bar code and decoding circuitry for decoding the imaged target bar code. Imaging systems include CCD arrays, CMOS arrays, or other imaging pixel arrays having a plurality of photosensitive elements or pixels (herein after referred to as an imaging array or photosensor array). Light reflected from a target image, e.g., a target bar code is focused through a lens of the imaging system onto the pixel array. Output signals from the pixels of the pixel array are digitized by an analog-to-digital converter. Decoding circuitry of the imaging and decoding system processes the digitized signals and attempts to decode the imaged bar code.

Two types of imaging system imaging sensors are typically used: a one dimensional (1D) photosensor array and a two dimensional (2D) photosensor array. A 1D photosensor array is characterized by a single row of photosensors or pixels, a 1×n array of 1 row and n columns of pixels, while a 2D photosensor array is characterized by multiple rows and multiple columns, an m×n array of m rows and n columns of photosensors or pixels.

In response to a need to include greater amounts of information in a bar code of limited overall horizontal width, high density bar codes have been developed which utilize bar code elements having very narrow widths. The ability of an imaging system utilizing a 1D or 2D photosensor array to successfully decode a high density bar code is dependent upon blur and pixels per module (PPM). PPM refers to the number of pixels imaging the smallest, that is, narrowest element of the bar code. For example, a PPM of 1 would indicate that the narrowest element of the bar code is being imaged by a single pixel of the imaging array, a PPM of 2 would indicate that the narrowest element of the bar code is being imaged by two pixels of the imaging array. Advanced imaging systems are able to successfully read, that is, image and decode a bar code with a PPM as low as 0.7. However, it is obvious that the ability of an imaging system to successfully read a high density bar code increases as PPM increases.

One solution to reading high density bar codes is to use an imaging system with more pixels. However, increasing pixel count increases imaging system cost. One solution to this problem has been addressed in U.S. application Ser. No. 11/228,210, filed on Sep. 15, 2005 and assigned to the assignee of the present invention. U.S. application Ser. No. 11/228,210 is incorporated herein in its entirety by reference. The aforementioned application disclosed utilizing a 1D photosensor array and moving the bar code reader at an acute angle with respect to a vertical axis of a presented target bar code. While this approach is useful, it is not readily applicable to hand-held bar code readers where the operator would have to move the bar code reader at an angle with respect to a horizontal axis of a bar code being read which is counterintuitive. Or if the bar code reader is stationary, the operator would have to present a bar code to be read at an angle with respect to the bar code reader window which, again, is counterintuitive for the operator.

What is needed is a bar code reader imaging system including a 2D photosensor array that may be utilized in a bar code reader capable of both hand-held and/or fixed position operation and that provides for enhanced ability to read high density bar codes without the necessity of increasing the number of pixels and without the necessity of orienting a window of the reader housing at an angle with respect to a target bar code when the reader is used in hand-held mode and orienting the target bar code at an angle with respect to the reader housing window when the reader is used in a fixed position.

### SUMMARY OF THE INVENTION

The present invention concerns an imaging-based, bar code reader including a housing and an imaging system supported within the housing. The imaging system includes a 2D photosensor array comprising an orthogonal array of pixels defining a sensor array surface. The housing further supports a transparent window through which reflected illumination from a target bar code is projected onto the sensor array surface of the 2D photosensor array positioned behind the window. When a target bar code is presented for reading, the target bar code is positioned in front of the window and the target bar code and housing window are oriented relative to each other such that a horizontal axis of the bar code is substantially aligned with a horizontal axis of the window. When an operator presents a bar code for reading, the bar code is not necessarily aligned with a horizontal axis of the window, but this is the intuitive orientation of presentation of the bar code.

The 2D photosensor array is oriented such that a horizontal axis of the sensor array surface is at an acute angle with respect to the horizontal axis of a bar code as the bar code would normally be presented for reading. In one preferred embodiment, the acute angle is 45 degrees.

In one preferred embodiment of the present invention, the reader housing is capable of both being used in a fixed position and in a hand-held mode. The housing includes a gripping portion adapted to be grasped by an operator and a forward portion extending from the gripping portion, the forward portion supporting the window. The bottom portion of the gripping portion is adapted to be received and supported in a docking station supported on a substrate such as a tabletop or sales counter. To facilitate using the reader in the hand-held mode, a leading or upper edge of the forward portion housing may be configured to be substantially parallel with the horizontal axis of the housing window to aid in alignment of the housing window with a target bar code since, in the hand-held mode, the operator is holding the gripping portion of the housing and pointing or aiming the forward portion of the housing toward the target code and, therefore, does not see the housing window but instead aligns the upper edge of the housing with the horizontal axis of the target bar code.

In the fixed potion mode, to read a target bar code, the target bar code is moved with respect to the reader housing such that a horizontal axis of the target bar code is aligned with the horizontal axis of the housing window.

In the hand-held mode, to read a target bar code, the housing is moved with respect to the target bar code such that the horizontal axis of the housing window is aligned with the horizontal axis of the target bar code.

These and other objects, advantages, and features of the exemplary embodiment of the invention are described in detail in conjunction with the accompanying drawings.

### BRIEF DESCRIPTION OF THE DRAWINGS

FIG. 1 is a schematic side elevation view of an exemplary embodiment of an imaging-based bar code reader of the present invention showing the external housing including a transparent window;

FIG. 2 is a schematic front elevation view of the bar code reader of FIG. 1;

FIG. 3 is a schematic top plan view of the bar code reader of FIG. 1;

FIG. 4 is a schematic view partly in section and partly in side elevation of a camera assembly of an imaging assembly of the bar code reader of FIG. 1;

FIG. 5 is a schematic block diagram of the bar code reader of FIG. 1;

FIG. 6 is a schematic representation of a prior art 2D photosensor array whose horizontal axis is aligned with a horizontal axis of a target bar code;

FIG. 7 is a schematic representation of a 2D photosensor array of the present invention whose horizontal axis is oriented at 45 degrees with respect to a horizontal axis of a target bar code; and

FIG. 8 is a schematic front view of an exemplary illumination system of the bar code reader of FIG. 1.

### DETAILED DESCRIPTION

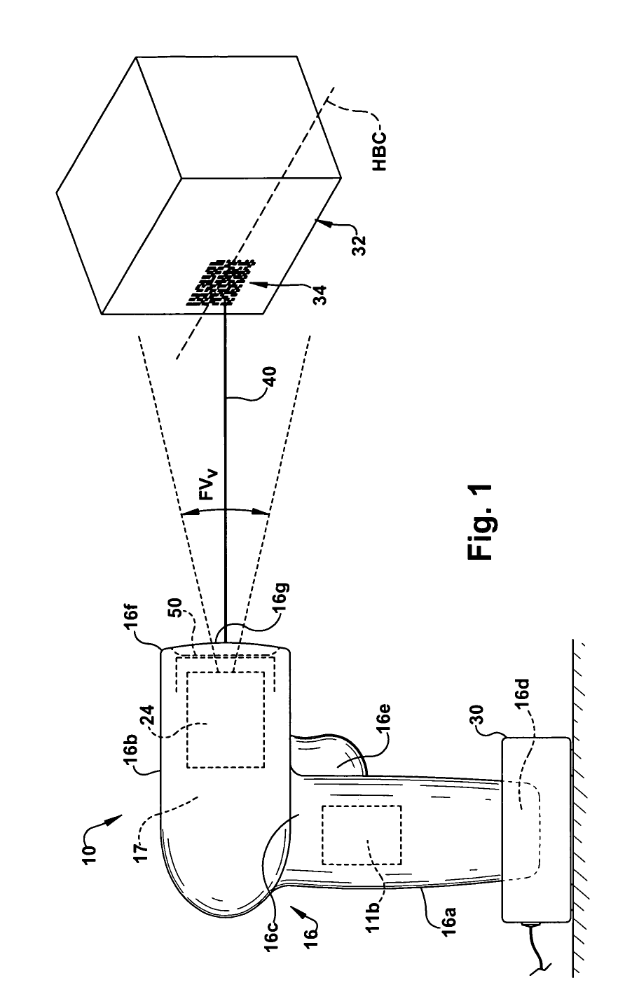

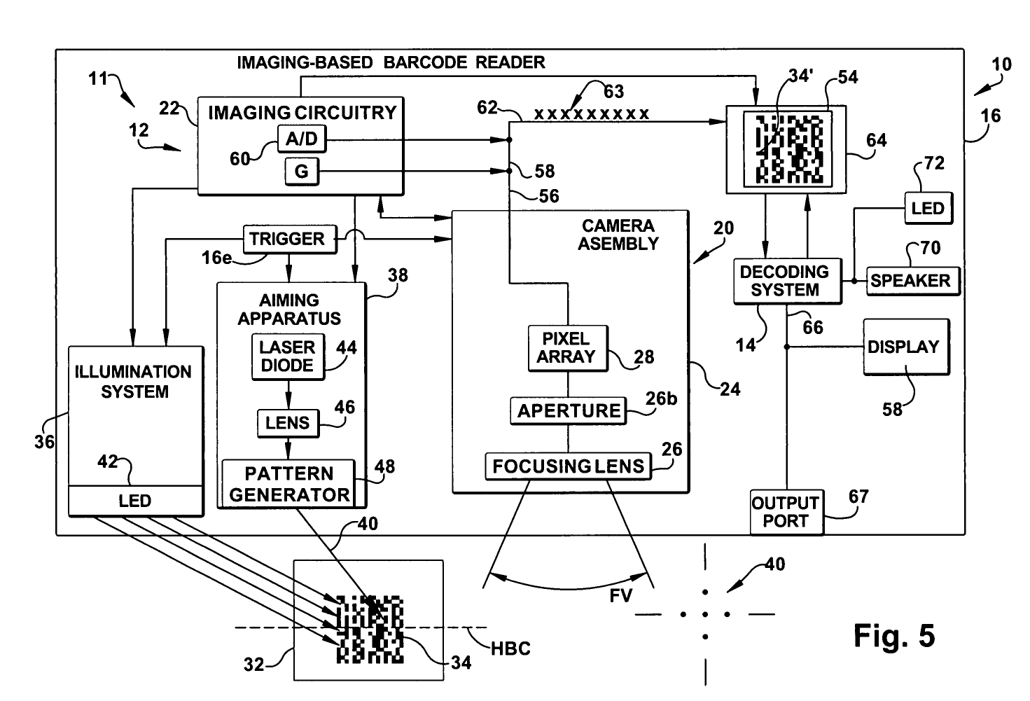

An exemplary embodiment of an imaging-based bar code reader is shown schematically at 10 in FIGS. 1-5. The bar code reader 10 includes a two dimensional (2D) imaging system 12 and a decoding system 14 mounted in a housing 16 and is capable of reading, that is, imaging and decoding both 1D and 2D bar codes and postal codes. The reader 10 is also capable of capturing images and signatures. The imaging system 12 is adapted to capture image frames of a field of view FV of the imaging system 20 and the decoding system 14 is adapted to decode encoded indicia within a captured image frame. The housing 14 supports circuitry 11 of the reader 10 including the imaging and decoding systems 12, 14 within an interior region 17 of the housing 16.

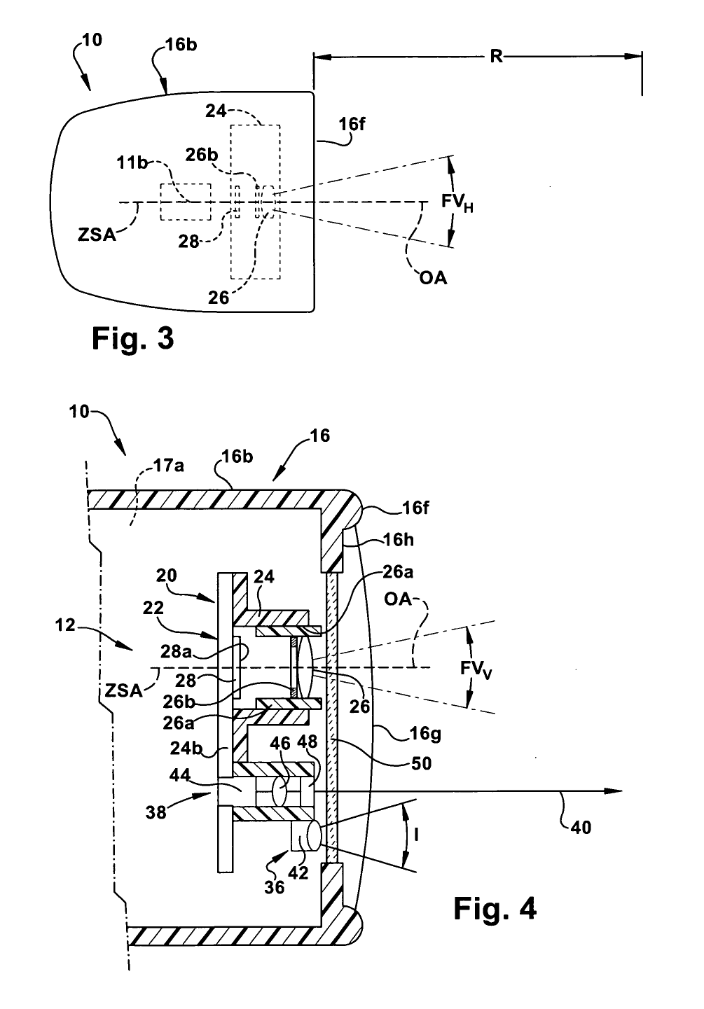

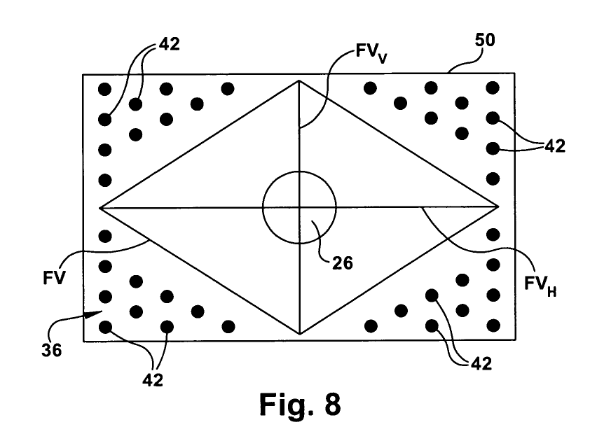

The imaging system 12 comprises an imaging camera assembly 20 and associated imaging circuitry 22. The imaging camera 20 includes a housing 24 supporting focusing optics including a focusing lens 26 and a 2D sensor or pixel array 28. The sensor array 28 is enabled during an exposure period to capture an image of a field of view FV of the imaging system 12. The field of view FV of the imaging system 12 is a function of both the configuration of the sensor array 28 and the optical characteristics of the focusing lens 26 and the distance and orientation between the array 28 and the lens 26. The imaging system 12 field of view FV (shown schematically in FIG. 8) includes both a horizontal and a vertical field of view, the horizontal field of view being shown schematically as FVH in FIG. 3 and the vertical field of view being shown schematically as FVV in FIGS. 1 and 4.

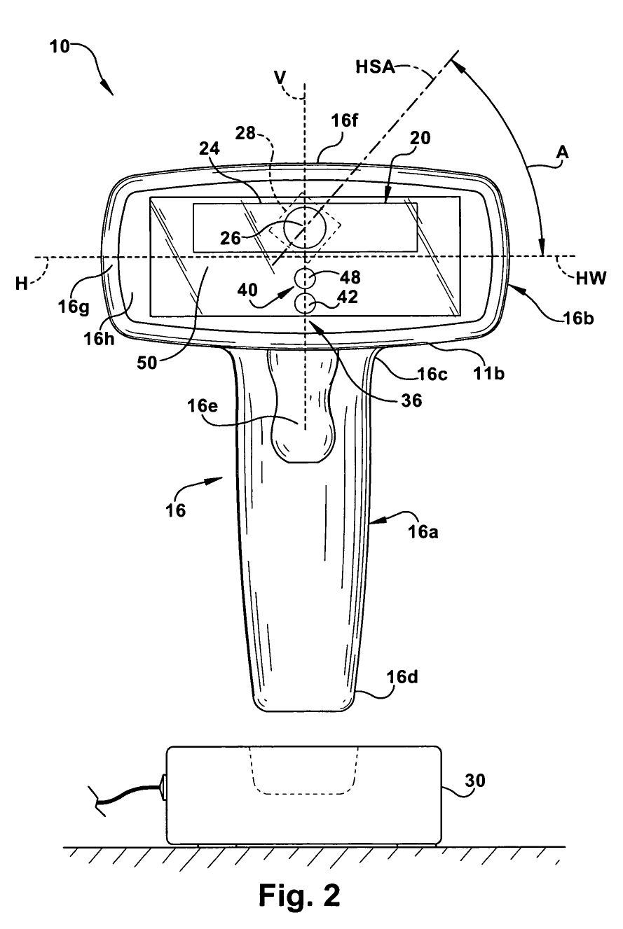

The housing 16 includes a gripping portion 16a adapted to be grasped by an operator's hand and a forward or scanning head portion 16b extending from an upper part 16c of the gripping portion 16a. A lower part 16d of the gripping portion 16a is adapted to be received in a docking station 30 positioned on a substrate such as a table or sales counter. The scanning head 16b supports the imaging system 12 within an interior region 17a (FIG. 4) of the scanning head 16. As can best be seen in FIG. 2, looking from the front of the housing 16, the scanning head 16b is generally rectangular in shape and defines a horizontal axis H and a vertical axis V. The vertical axis V being aligned with a general extent of the gripping portion 16a.

Advantageously, the reader 10 of the present invention is adapted to be used in both a hand-held mode and a fixed position mode. In the fixed position mode, the housing 16 is received in the docking station 30 and an object 32 having a target bar code 34 is brought within the field of view FV of the reader's imaging system 12 in order to have the reader 10 read the target bar code 34. The imaging system 12 is typically always on or operational in the fixed position mode to image and decode any target bar code presented to the reader 10 within the field of view FV. The docking station 30 is plugged into an AC power source and provides regulated DC power to circuitry 11 of the reader 10. Thus, when the reader 10 is in the docking station 30 power is available to keep the imaging system 12 on continuously.

In the hand-held mode, the housing 14 is removed from the docking station 20 so the reader 10 can be carried by an operator and positioned such that the target bar code 26 is within the field of view of the imaging system 12. In the hand-held mode, imaging and decoding of the target bar code 26 is instituted by the operator depressing a trigger 16e extending through an opening near the upper part 16c of the gripping portion 16a.

The imaging system 12 is part of the bar code reader circuitry 11 which operates under the control of a microprocessor 11a. When removed from the docking station 30, power is supplied to the imaging and decoding systems 12, 14 by a power supply 11b. The imaging and decoding systems 12, 14 of the present invention may be embodied in hardware, software, firmware or electrical circuitry or any combination thereof.

The bar code reader 10 includes an illumination system 36 to illuminate the target bar code 34 and an aiming system 38 which generates a visible aiming pattern 40 to aid the operator in aiming the reader 10 at the target bar code 34 when using the reader in the hand-held mode. The illumination system 36 typically includes one or more illumination LEDs 42 which are energized to direct illumination approximately along the field of view FV of the focusing lens 26 of the imaging system 12 (shown as I in FIG. 4).

While the schematic representation of the illumination assembly 36 shown in FIG. 4 includes a single LED 42, it should be recognizes that a plurality of LEDs 42 surrounding the field of view FV of the imaging system focusing lens 26 may advantageously provide for more uniform illumination of the target bar code 34 thereby avoiding shadows that might result from a single LED and, thus, enhancing decodability. Further, a plurality of LEDs 42 may provide for greater illumination intensity on the target bar code 34 which under poor ambient lighting conditions, may also enhance decidability.

One exemplary embodiment of an illumination assembly 36 including a plurality of LEDs 42 is shown schematically in FIG. 8 looking inwardly into the reader 10 through the window 50. As can be seen in FIG. 8, the plurality of LEDs 42 are positioned behind and in alignment with the window 50 and outwardly of the focusing lens 26 for focusing illumination along the field of view FV of the focusing lens 26. The plurality of LEDs are positioned to surround the focusing lens field of view FV at the point the field of view passes through the window 50.

The aiming system 38 generates the visible aiming pattern 40 comprising a single dot of illumination, a plurality of dots and/or lines of illumination or overlapping groups of dots/lines of illumination and typically includes a laser diode 44, a focusing lens 46 and a pattern generator 48 for generating the desired aiming pattern 40.

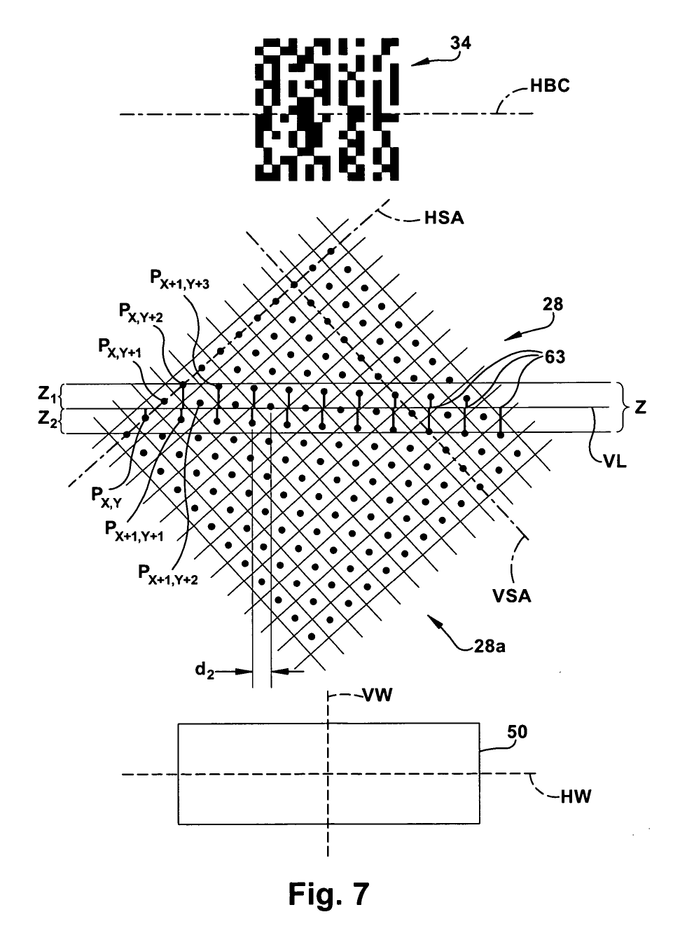

The camera housing 24 is positioned within the housing interior region in proximity to a transparent window 50 defining a portion of a front wall 16h of the housing scanning head 16b. The window 50 is oriented such that its horizontal axis HW (FIGS. 2 & 7) is substantially parallel to the scanning head horizontal axis H and its vertical axis VW (FIG. 7) is substantially parallel to the scanning head vertical axis V. Reflected light from the target bar code 34 passes through the transparent window 50, is received by the focusing lens 26 and focused onto the imaging system sensor array 28. In an embodiment, the illumination assembly 36 and the aiming assembly 38 may be positioned behind the window 50. Illumination from the illumination LEDs 42 and the aiming pattern 40 generated by the aiming assembly 38 also pass through the window 50. While the illumination

When actuated to read the target bar code 34, the imaging system 12 captures an image frame 54. The image frame 54 includes an image 34′ of the target bar code 34 (shown schematically in FIG. 4). The decoding system 14 decodes a digitized version of the image bar code 34′. The imaging circuitry 22 may be disposed within, partially within, or external to the camera assembly housing 24. Shown schematically in FIG. 2, the imaging camera housing 24 is supported with the scanning head 16b of the housing 16. The focusing lens 26 is supported by a lens holder 26a. The camera housing 24 defines a front opening 24a that supports and seals against the lens holder 26a so that the only illumination incident upon the sensor array 28 is illumination passing through the focusing lens 26. Depending on the specifics of the camera assembly 20, the lens holder 26a may slide in and out within the camera housing front opening 24a to allow dual focusing under the control of the imaging circuitry 22 or the lens holder 26a may be fixed with respect to the camera housing 25 in a fixed focus camera assembly. The lens holder 26a is typically made of metal. A back end of the housing 24 may be comprised of a printed circuit board 24b, which forms part of the imaging circuitry 22 and may extend beyond the housing 24 to support the illumination system 36 and the aiming apparatus 38.

The imaging system 12 includes the sensor array 28 of the imaging camera assembly 20. The sensor array 28 comprises a charged coupled device (CCD), a complementary metal oxide semiconductor (CMOS), or other imaging pixel array, operating under the control of the imaging circuitry 22. In one exemplary embodiment, the sensor array 28 comprises a two dimensional (2D) mega pixel CCD array with a typical size of the pixel array being on the order of 1280×1024 pixels. The illumination-receiving pixels of the pixel array define a sensor array surface 28a (best seen in FIG. 4). The pixel array 28 is secured to the printed circuit board 24b, in parallel direction for stability. The sensor array surface 28a is substantially perpendicular to an optical axis OA of the focusing lens 26, that is, a z axis (labeled ZSA in FIG. 4) that is perpendicular to the sensor array surface 28a would be substantially parallel to the optical axis OA of the focusing lens. The pixels of the sensor array surface 28a are disposed in an orthogonal arrangement of rows and columns of pixels that define a horizontal axis HAS and a vertical axis VSA of the sensor array 28a (FIG. 7).

As is best seen in FIG. 4, the focusing lens 26 focuses light reflected from the target bar code 34 through an aperture 26b onto the sensor array surface 28a of the pixel/photosensor array 28. Thus, the focusing lens 26 focuses an image of the target bar code 14 (assuming it is within the field of view FV) onto the array of pixels comprising the pixel array 28. The focusing lens 26 field of view FV includes both a horizontal and a vertical field of view. The optics of the focusing lens 26 and the position of the camera housing 24 with respect to the window 50 are selected such that the field of view FV of the focusing lens encompasses an area to the front of the window 50 that is aligned with but larger than the area of the window 50 itself to facilitate reading of the bar code 34 even if the operator does not properly align the bar code 34 with the window 50.

Electrical signals are generated by reading out of some or all of the pixels of the pixel array 28 after an exposure period. After the exposure time has elapsed, some or all of the pixels of pixel array 28 are successively read out thereby generating an analog signal 56 (FIG. 4). In some sensors, particularly CMOS sensors, all pixels of the pixel array 28 are not exposed at the same time, thus, reading out of some pixels may coincide in time with an exposure period for some other pixels.

The analog image signal 56 represents a sequence of photosensor voltage values, the magnitude of each value representing an intensity of the reflected light received by a photosensor/pixel during an exposure period. The analog signal 46 is amplified by a gain factor, generating an amplified analog signal 58. The imaging circuitry 22 further includes an analog-to-digital (A/D) converter 60. The amplified analog signal 58 is digitized by the A/D converter 60 generating a digitized signal 62. The digitized signal 62 comprises a sequence of digital gray scale values 63 typically ranging from 0-255 (for an eight bit processor, i.e., 2⁸=256), where a 0 gray scale value would represent an absence of any reflected light received by a pixel during an exposure or integration period (characterized as low pixel brightness) and a 255 gray scale value would represent a very intense level of reflected light received by a pixel during an exposure period (characterized as high pixel brightness).

The digitized gray scale values 63 of the digitized signal 62 are stored in a memory 64. The digital values 63 corresponding to a read out of the pixel array 28 constitute the image frame 54, which is representative of the image projected by the focusing lens 26 onto the pixel array 28 during an exposure period. If the field of view FV of the focusing lens 26 includes the target bar code 34, then a digital gray scale value image 14′ of the target bar code 14 would be present in the image frame 54.

The decoding circuitry 14 then operates on the digitized gray scale values 63 of the image frame 54 and attempts to decode any decodable image within the image frame, e.g., the imaged target bar code 14′. If the decoding is successful, decoded data 66, representative of the data/information coded in the bar code 34 is then output via a data output port 67 and/or displayed to a user of the reader 10 via a display 68. Upon achieving a good “read” of the bar code 34, that is, the bar code 34 was successfully imaged and decoded, a speaker 70 and/or an indicator LED 72 is activated by the bar code reader circuitry 13 to indicate to the user that the target bar code 14 has successfully read, that is, the target bar code 14 has been successfully imaged and the imaged bar code 14′ has been successfully decoded.

Orientation of Sensor Array 28

The ability to successfully read bar codes, especially high density 2D bar codes, is enhanced by increasing the PPM (pixels per module or the number of active pixels) of the sensor array 28, particularly, increasing the PPM along a horizontal axis HBC of the target bar code 34. Advantageously, because of the orientation of the photosensor array 28 of the imaging system 12, the reader 10 of the present invention has improved horizontal imaging resolution resulting from an effective increase in horizontal PPM.

PPM is a measure of the number of pixels that detect the reflected illumination from the smallest (narrowest) feature of a target bar code. A feature of a bar code may be, for example, a black block or a white block of a 2D DataMatrix bar code or the black line or white stripe of a row of a 2D PDF417 bar code.

It would appear that a PPM value of 1 or more would be needed to successfully decode an imaged bar code because each feature of the bar code 34 would have to be imaged by at least one pixel in order to be captured in the imaged bar code 34′ and subsequently be decoded. However, with sophisticated decoding algorithms, successful decoding can occur at a PPM value of slightly less than 1 PPM (around 0.7 PPM).

The reason that increasing PPM in the horizontal direction is of special importance is that most operators present a target bar code to a reader for reading such that the bar code is horizontally aligned with respect to a horizontal axis H of the scanning head 16b. For example, when the reader 10 is used in the fixed position mode, it is natural for the operator to present the target bar code 34 to the reader scanning head 16b horizontally. In other words, it is natural for the operator to move the object 32 with respect to the scanning head 16b such that the bar code 34 is positioned in front of the window 50 and a horizontal axis HBC of the bar code 34 is at least approximately aligned with the horizontal axis H of the scanning head and the horizontal axis HW of the scanning head window 50. The operator will typically attempt to maintain the position of the bar code 34 in this position with respect to the window 50 until an audible beep from the speaker 70 is heard and/or a flash from the indicator LED 72 is seen indicating a successful read of the target bar code 34.

In the hand-held mode, aided by the projected aiming pattern 40 projected by the aiming assembly 38, the operator moves the reader 10 toward and aims the scanning head 16b at the target bar code 34 until a successful read signal is received. In the fixed position mode, the operator can view both the window 50 and the target bar code 34 as the object 32 is brought into proximity of the reader 10. However, in the hand-held mode, the operator does not see the window 50 as the reader 10 is aimed at the target bar code 34 because typically the operator's head is behind the reader 10 as the operator extends his or her gripping hand forwardly toward the object 32. Nevertheless, it is natural for the operator to attempt to at least approximately align an upper, forward distal edge 16f of the scanning head 16b with the horizontal axis H of the target bar code 34. In this position, the horizontal axis H of the scanning head 16b would be at least approximately aligned with the horizontal axis HBC of the target bar code 34.

In the present invention, in order to effectively increase the PPM along the horizontal axis HBC of the target bar code 34, the sensor array 28 is rotated about the z axis ZSA of the sensor array surface 28a such that the horizontal axis HSA of the sensor array surface 28a is oriented at an acute angle A (shown in FIGS. 2 and 7) with respect to the horizontal axis HBC of the target bar code 34 when the bar code is presented to the reader 10 for reading. This presumes that the operator, when using the reader 10, will attempt to align the horizontal axis HBC of the target bar code 34 with the horizontal axis H of the scanning head 16b and/or the horizontal axis HW of the window 50. Preferably, the sensor array surface 28a is oriented such that its horizontal axis HSA at an acute angle of 45 degrees with respect to the horizontal axis HBC of the target bar code 34 when the bar code is presented for reading. Doing so results in the PPM increase of approximately 41% when PPM is measured in the horizontal direction (that is, when measured with respect to the horizontal axis H of the window 50).

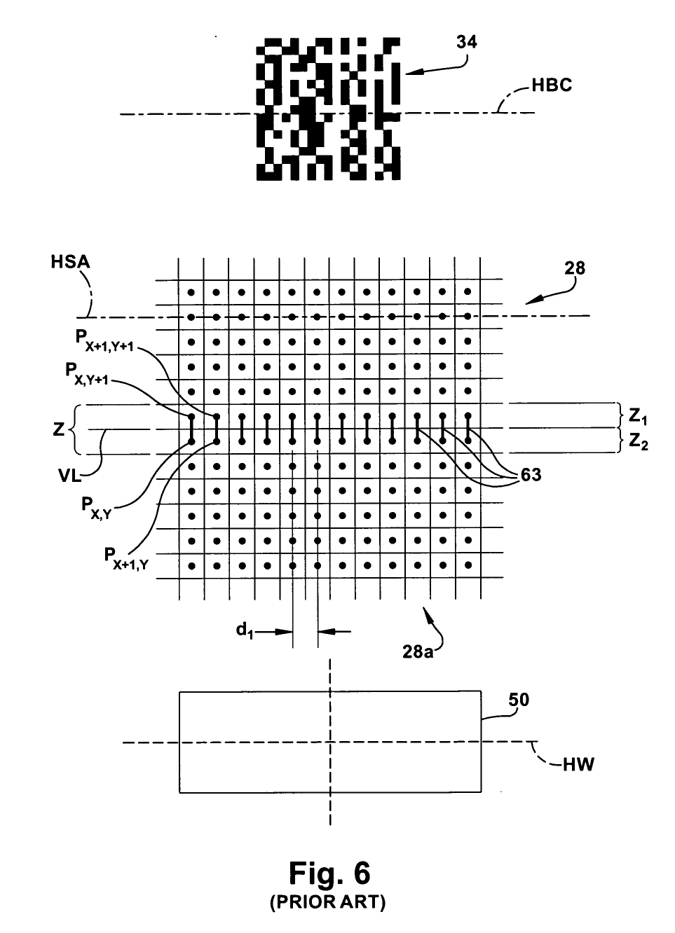

The effect of orienting the sensor array 28 at a substantially 45 degree angle with respect to the horizontal axis HBC of the target bar code 34 is illustrated schematically in the comparison of FIGS. 6 and 7. In FIGS. 6 and 7, individual pixels of an active area of the sensor array 28 are represented by points centered in each square of an orthogonal array of squares. In FIG. 6, a prior art embodiment is shown wherein the horizontal axis HAS of the sensor array 28 is oriented parallel to the horizontal axis HBC of the target bar code 34 which, for illustration purposes has been drawn in above the sensor array 28. The imaged bar code 34′ would be in the same orientation as the bar code 34 in FIG. 6 but would be superimposed or imaged on the sensor array surface 28a.

PPM will be a function of the horizontal distance d1 between adjacent horizontal pixels. In the case of prior art FIG. 6, the distance between adjacent horizontal pixels (from center point to center point of adjacent horizontal pixels) is d1. Prior to decoding, the imaging system 12 draws a virtual scan line VL orthogonally across the imaged bar code 34′ and establishes a zone Z, extending above and below the virtual scan line VL. The zone Z is established by upper and lower bounds Z1, Z2 that extend parallel to the virtual line VL. The width of the zone Z is determined empirically. For example, the width of the zone Z may correspond to a distance between vertically adjacent pixel locations, horizontally adjacent pixel locations, as represented in memory 64, or some other distance that is empirically determined.

The gray scale values 63 of the imaged bar code 34′ within the zone Z are orthogonally projected onto the virtual line VL. This is shown schematically in FIG. 6 where the gray scale values 63 of the pixels within the zone Z are orthogonally projected on the virtual line VL. As can be seen in FIG. 6, even if the zone Z were increased in size, it would be of little benefit because since the pixels are vertically aligned with respect to the virtual scan line VL, the projected gray scale values would tend to be “clumped” together, that is, nonuniformly distributed along the virtual scan line VL. For example, the gray scale values associated with pixel Px,y and Px,y+1 project onto the same (or almost the same) point on the virtual scan line VL. Similarly, the gray scale values associated with pixel Px+1,y and Px+1,y+1 project onto the same (or almost the same) point on the scan line VL. Since the decoding system 14 analyzes the gray scale values projected onto a scan line in an attempt to determine what regions of the image frame 54 correspond to bar and space features of the imaged bar code 34′, the more uniform the distribution of gray scale values along the scan line, the better the chance of successfully decoding the imaged bar code 34′. The nonuniformity of the projected gray scale values illustrated in prior art FIG. 6 tends to degrade decodability.

Turning to FIG. 7, as taught by the present invention, the horizontal axis HSA of the sensor array 28 now has been rotated approximately 45 degrees with respect to the horizontal axis HBC of the target bar code 34 which for illustration purposes is drawn above the sensor array 28. The imaged bar code 34′ would be in the same orientation as the bar code 34 in FIG. 7 but would be superimposed or imaged on the sensor array surface 28a. Also, for illustration purposes, the scanning head window 50 is drawn below the sensor array 28.

It should be noted that, in actual practice, the angle of rotation A would be slightly greater or less than 45 degrees to avoid the vertical alignment of pixels that would result if exact 45 degree angle is selected. In FIG. 7, the angle of rotation is slightly less than 45 degrees. Alternately, if the angle of rotation is selected to be exactly 45 degrees, the scan line VL could be tilted just slightly from horizontal to again avoid the vertical alignment of pixels.

PPM will be a function of the horizontal distance d2 between centers of adjacent pixels. Given that the photosensor arrays shown in FIGS. 6 and 7 are identical in physical configuration, by geometry, it is clear that d2 is smaller than d1 and, approximately, d2=(cos 45°)(d1). Since cos 45°=0.707, the number of pixels in the horizontal direction that a given horizontal bar code feature will be projected onto will be increased by approximately 40% (that is, 1/cos 45°=1.414). Thus, in the horizontal direction, orienting the sensor array 28 such that its horizontal axis is at 45 degrees with respect to the horizontal axis HBC of the target bar code 34 will increase PPM by approximately 40% with respect to the same sensor array 28 oriented parallel to the horizontal axis HBC of the target bar code 34. Increasing the horizontal PPM enhances a working range of the reader 10 with respect to bar codes whose readability is limited by PPM considerations. Advantageously, the working range is a range in front of the reader 10 at which the target bar code 34 may be successfully read. For the reader 10, the working range extends from contact to a maximum distance (shown as R in FIG. 3). Contact means that the reader 10 can read a bar code that is placed against a forward distal edge 16g of the scanning head 16b. The value of R will depend on various factors including the size of the bar code features, the clarity of the bar code imprinting, the ambient light conditions, etc.

Looking at the virtual scan line VL in FIG. 7, it is clear that for a given zone size Z, orienting the sensor array surface 28a at an angle with respect to the target bar code 34 results in effectively more gray scale values being projected onto the virtual scan line VL because the gray scale value vertical alignment problem is overcome. For example, in FIG. 7, pixels Px,y, Px,y+1, Px,y+2, Px+1,y+1, Px+1,y+2 and Px+1,y+3 are all within zone Z and, thus, the gray scale values 63 associated with these pixels would be orthogonally projected onto the scan line VL. As can be seen in FIG. 7, when the pixel gray scale values 63 are orthogonally projected onto the scan line VL, there are more gray scale values projected onto the scan line VL. Additionally, the nonuniformity of the projected gray scale values onto the scan line VL (shown in FIG. 6) is mitigated. Increasing the effective number of gray scale values projected onto the virtual line VL, together with decreasing the nonuniformity of the distribution of the gray scale values 63 along the virtual scan line VL results in improved capability of decoding high density bar codes by the decoding system 14.

While the present invention has been described with a degree of particularity, it is the intent that the invention includes all modifications and alterations from the disclosed design falling with the spirit or scope of the appended claims.

1. An imaging based bar code reader for imaging and decoding a: target bar code, the reader comprising:
a housing including a scanning head defining having a front through which imaging is performed and defining a horizontal axis when viewed from the front of the scanning had;
an imaging system supported by the scanning head for imaging the target bar code, the imaging system including a 2D sensor array and focusing optics receiving reflected illumination from the target bar code and focusing the reflected illumination onto a sensor array surface of the sensor array, the sensor array surface including an orthogonal array of pixels and defining a horizontal axis and a vertical axis, the horizontal and vertical axes of the sensor array surface being substantially perpendicular to an optical axis of the focusing optics; and
wherein the sensor array is oriented such that the horizontal axis of the sensor array surface is at an acute angle with respect to a horizontal axis of the scanning head.

2. The bar code reader of claim 1 wherein a transparent window is supported in the scanning head, reflected illumination from the target bar code passing through the window, the window defining a horizontal axis and the target bar code being presented to the scanning head for reading such that the horizontal axis of the target bar code is substantially aligned with the horizontal axis of the window.

3. The bar code reader of claim 1 wherein the acute angle is substantially 45 degrees.

4. The bar code reader of claim 1 wherein the sensor array is a selected one of a CCOD sensor array or a CMOS sensor array.

5. The bar code reader of claim 2 wherein the housing includes a gripping portion and the scanning head extends from the gripping portion and further wherein the window is supported within a forward facing wall of the scanning head.

6. The bar code reader of claim 1 wherein the housing is adapted to carried about by an operator of the reader.

7. The bar code reader of claim 1 wherein the housing is removably received in a docking station for use in a fixed position.

8. The bar code reader of claim 1 wherein the sensor array and the focusing optics are components of a camera assembly positioned within an interior region of the scanning head.

9. The bar code reader of claim 2 further including an illumination system for protecting illumination along a field of view of the focusing optics to illuminate the target bar code.

10. The bar code reader of claim 9 wherein the illumination system includes a plurality of LEDs positioned behind and in alignment with the window and outwardly of the focusing lens for focusing illumination along the field of view of the focusing lens 26, the plurality of LEDs are positioned to surround the focusing lens field of view at a point the field of view passes through the window.

11. The bar code reader of claim 1 further including an aiming pattern for generating an aiming pattern to aid an operator in aiming the housing at the target bar code.

12. An imaging based bar code reader for imaging and decoding a target bar code, the reader comprising:
a housing including a transparent window;
an imaging system supported by the housing for imaging the target bar code, the imaging system including a 2D sensor array and focusing optics receiving reflected illumination from the target bar code through the window and focusing the reflected illumination onto a sensor array surface of the sensor array, the sensor array surface including an orthogonal array of pixels and defining a horizontal axis and a vertical axis, the horizontal and vertical axes of the sensor array surface being substantially perpendicular to an optical axis of the focusing optics; and
wherein the sensor array is oriented such that the horizontal axis of the sensor array surface is at an acute angle with respect to a horizontal axis of the transparent window.

13. The bar code reader of claim 12 wherein the acute angle is substantially 45 degrees.

14. The bar code reader of claim 12 wherein the sensor array is a selected one of a CCD sensor array or a CMOS sensor array.

15. The bar code reader of claim 12 wherein the housing includes a gripping portion and a scanning head extending from the gripping portion and further wherein the window is supported within a forward facing wall of the scanning head.

16. The bar code reader of claim 12 wherein the housing is adapted to be carried about by an operator of the reader.

17. The bar code reader of claim 12 wherein the housing is removably received in a docking station for use in a fixed position.

18. The bar code reader of claim 12 wherein the sensor array and the focusing optics are components of a camera assembly positioned within an interior region of the housing.

19. The bar code reader of claim 12 further including an illumination system for projecting illumination along a field of view of the focusing optics to illuminate the target bar code.

20. The bar code reader of claim 19 wherein the illumination system includes a plurality of LEDs positioned behind and in alignment with the window and outwardly of the focusing lens for focusing illumination along the field of view of the focusing lens 26, the plurality of LEDs are positioned to surround the focusing lens field of view at a point the field of view passes through the window.

21. The bar code reader of claim 12 further including an aiming pattern for generating an aiming pattern to aid an operator in aiming the housing at the target bar code.

22. The bar code reader of claim 12 wherein the housing includes an upper edge that extends generally parallel to the horizontal axis of the window.
